(19) United States
(12) Patent Application Publication
(10) Pub. No.: US 2006/0256006 A1
(43) Pub. Date: Nov. 16, 2006

(54) Receiver with increased sensitivity

(76) Inventor: Tomas Nylen, Upplands Vasby (SE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/408,355

(22) Filed: Apr. 21, 2006

(30) Foreign Application Priority Data
Apr. 21, 2005 (EP) EP05008804.6

(51) Int. Cl. G01S 5/14; H01Q 3/00; H04B 7/185

(52) U.S. Cl. 342/357.06; 342/359; 342/372

(57) ABSTRACT

The invention relates to a receiver for a satellite based navigation system. The receiver comprises an antenna with multiple sectors, a controller associated with the antenna, and an orientation device connected to the controller. The invention determines a current orientation of the receiver, and dynamically controls the system so that signals from each satellite are received by using the sector of the antenna with the highest gain in the current direction of the satellite, in order to increase the sensitivity of the receiver.

### REFERENCE TO RELATED APPLICATIONS

This application claims the benefit of the priority date of European application EP 05 008 804.6, filed on Apr. 21, 2005, the contents of which are herein incorporated by reference in their entirety.

### FIELD OF THE INVENTION

The present invention relates to a receiver for a satellite based navigation system, and to a method for increasing the sensitivity of a receiver for a satellite based navigation system.

### BACKGROUND OF THE INVENTION

Today it is common practice to have a portable unit with a receiver for a satellite based navigation system to be able to determine a current position of the portable unit. This portable unit comprises an omni-directional antenna to receive the signals from the satellites. The antenna usually used in this context is an antenna with only one antenna lobe. One known antenna with only one antenna lobe is a patch antenna with a semispherical antenna lobe.

A drawback in using such an antenna is that the use of an omni-directional antenna increases the probability of receiving reflected signals. Another drawback with the use of an omni-directional antenna is that a lot of noise is received, resulting in difficulties in distinguishing the satellite signals.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

One embodiment of the invention is directed to a receiver for a satellite based navigation system, wherein the receiver is configured for use in a portable unit. The receiver comprises an antenna with n number of sectors, wherein n is an integer, and n≧2. The receiver comprises a control device associated with the antenna. The receiver further comprises an orientation device connected to the control device, that is configured to determine a current orientation of the receiver. The control device dynamically controls that signals from each satellite are received by using the sector of the antenna with the highest gain in a current direction of the satellite, wherein the sector of the antenna is used based on the location of a satellite associated with satellite signal to be received and based on a current orientation of the receiver. The receiver according to the invention implies increased sensitivity of the receiver, and makes use of the increased antenna gain in each sector, compared to a traditional omni-directional antenna. Another advantage associated with this receiver is that multipath, i.e. reflected, satellite signals are attenuated.

In another embodiment, a further advantage is achieved when the orientation device comprises a compass and a tilt sensor configured to sense and determine a current tilt of the receiver.

According to another embodiment, the orientation device comprises a compass and a gyro device.

According to yet another embodiment, the orientation comprises a three axis compass.

Furthermore, in another embodiment, the receiver comprises a switch matrix connected to the antenna and to the control device with n inputs and m outputs, wherein m is an integer, and m<n, and m RF digitizer channels connected to the switch matrix, wherein the switch matrix is configured to distribute signals from the antenna sectors to the RF digitizer channels with the aid of control signals from the control device.

According to another embodiment, the receiver comprises n RF digitizer channels, wherein each of them is connected to a sector of the antenna.

In still another embodiment, each of the RF digitizer channels comprise an amplifier configured to amplify signals from the antenna sectors, a mixing device connected to the amplifier and configured to mix down the amplified signals to a lower frequency band, and an analog/digital converter connected to the mixing device.

Furthermore, in yet another embodiment, the receiver comprises a processor connected to each analog/digital converter, and configured to process the digital signals from the analog/digital converter.

In one example, the portable unit may comprise a mobile telephone, a mobile communicator, a personal digital assistant, a handheld computer, a navigation equipment, or a portable computer.

Furthermore, in one embodiment, the receiver comprises a GPS receiver or an Assisted GPS receiver. In another example, the receiver comprises a Galileo receiver, or an Assisted Galileo receiver. According to another embodiment, the receiver comprises a Galileo receiver and a GPS receiver combined together.

Furthermore, the invention is also directed to a method for increasing the sensitivity of a receiver for a satellite based navigation system, wherein the receiver is intended for use in a portable unit. The method comprises determining a current orientation of the receiver and determining a current position of each satellite with the aid of satellite navigation data. With the aid of a controller in the receiver, dynamically controlling the receiver so that signals from each satellite are received by using a particular sector out of n available sectors of an antenna, wherein the particular sector provides the highest gain in a current direction of the satellite. In one embodiment, the particular sector is selected based on the location of a satellite providing the received signals and on a current orientation of the receiver. The method according to one aspect of the invention increases the sensitivity of an embedded receiver, and makes use of the increased antenna gain in each sector, compared to a traditional omni-directional antenna. Another advantage with this method is that multipath effects, i.e. reflected satellite signals are attenuated.

In accordance with another embodiment, a further advantage is achieved if the determination of a current orientation of the receiver comprises determining the direction of the receiver in relation to the magnetic north with the aid of a compass within the receiver, and sensing and determining a current tilt of the receiver with the aid of a tilt sensor within the receiver.

According to another embodiment, determining a current orientation of the receiver comprises determining the direction of the receiver in relation to the magnetic north with the aid of a compass within the receiver and sensing and determining a current tilt of the receiver with the aid of a gyro within the receiver.

According to yet another embodiment, determining a current orientation of the receiver is performed with the aid of a three axis compass within the receiver.

In another embodiment, the method also comprises distributing signals from the antenna sectors to a number of RF digitizer channels within the receiver with the aid of control signals the said controller. The control signals control a switch matrix with a number of inputs, and a number of outputs.

According to another embodiment, the method can further comprise forwarding signals from the antenna sectors to the number RF digitizer channels. A further advantage in this context is achieved if the method also comprises amplifying the signals from the antenna sectors. The amplified signals are then mixed down to a lower frequency band and an analog/digital conversion is performed on each signal.

Furthermore, it is advantageous if the method also comprises processing the digital signal after the analog/digital conversion.

A further advantage may be achieved if the portable unit comprises a mobile telephone, a mobile communicator, a personal digital assistant, a handheld computer, a navigation equipment, or a portable computer.

Furthermore, it may be advantageous if the receiver comprises a GPS receiver or an Assisted GPS receiver. It may also be advantageous, if the receiver comprises a Galileo receiver or an Assisted Galileo receiver. According to a further embodiment of the method, the receiver comprises a combination of a Galileo receiver and a GPS receiver.

In yet another embodiment, the invention provides at least one computer program product for increasing the sensitivity of a receiver for a satellite based navigation system, wherein the receiver is intended for use in a portable unit. The product(s) is/are directly loadable into the internal memory of at least one digital computer, and wherein the at least one computer program product comprises software code portions for performing the method according to the invention, when the at least one product is/are run on the at least one computer. The computer program product(s) according to the invention increase(s) the sensitivity of an embedded receiver, and make(s) use of the increased antenna gain in each sector, compared to a traditional omni-directional antenna. Another advantage with this/these computer program product(s) is that multipath effects, i.e. reflected, satellite signals are attenuated.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

Embodiments of the invention will now be described with reference to the accompanying drawings, in which:

FIG. 1 is a block diagram of one embodiment of a receiver for a satellite based navigation system according to the invention;

FIG. 2 is a block diagram of another embodiment of a receiver for a satellite based navigation system according to the invention;

FIG. 3 is a flow chart of a method for increasing the sensitivity of a receiver for a satellite based navigation system according to another embodiment of the invention;

FIG. 4 is a more detailed flow chart illustrating one embodiment of the method disclosed in FIG. 3;

FIG. 5 is a more detailed flow chart illustrating another embodiment of the method disclosed in FIG. 3; and

FIG. 6 is a schematic diagram of a computer program product according to another embodiment of the invention.

### DETAILED DESCRIPTION OF THE INVENTION

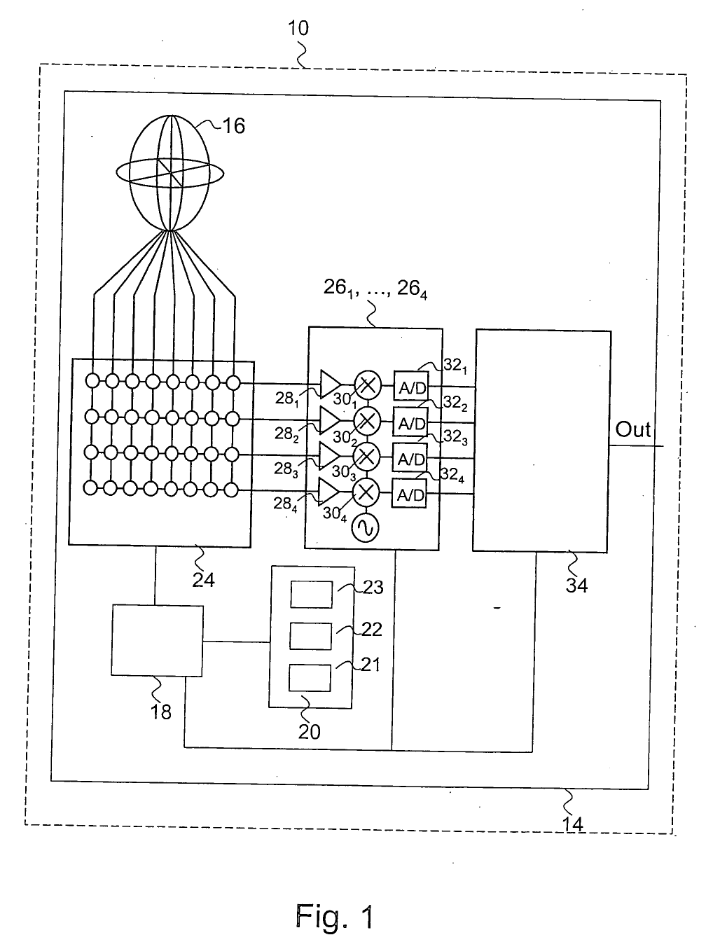

FIG. 1 illustrates a block diagram of a receiver 14 according to one embodiment of the invention which enables to increase the sensitivity of the receiver for a satellite based navigation system, wherein the receiver 14 is intended for use in a portable unit 10 as shown in FIG. 1. The receiver 14 comprises an antenna 16 with 8 antenna sectors. In FIG. 1 eight sectors are shown, but the general case comprises a number n of sectors, wherein n is an integer, and n≧2. The receiver 14 also comprises a switch matrix 24 connected to the 8 antenna sectors of the antenna 16. The switch matrix 24 shown in FIG. 1 has 8 inputs and four outputs. Generally, the switch matrix 24 comprises n inputs, and m outputs, wherein m is an integer, and m<n. The receiver 14 also comprises a control device 18 connected to four RF digitizer channels 26₁, . . . , 26₄, and to a processor 34. Also connected to the control device 18 is an orientation device 20 configured to determine a current orientation of the receiver 14. According to one example, the orientation device 20 comprises a compass 21, and a tilt sensor 22 configured to sense and determine a current tilt of the receiver 14. According to another example, the orientation device 20 comprises a compass 21, and a gyro 23. According to a third example, the orientation device 20 is configured as a three axis compass. As illustrated in FIG. 1, the outputs of the switch matrix 24 are connected to four RF digitizer channels 26₁-26₄. The switch matrix 24 is configured to distribute signals from the 8 antenna sectors to the 4 RF digitizer channels 26₁-26₄ with the aid of control signals from the control device 18. As can be seen in FIG. 1, each RF digitizer channel 26₁-26₄ comprises an amplifier 28₁-28₄ configured to amplify the signals from the antenna sectors, a mixing device 30₁-30₄ connected to the amplifier 28₁-28₄ and configured to mix down the amplified signals to a lower frequency band, and an analog/digital converter 32₁-32₄ connected to the mixing means 30₁-30₄ configured to convert the analog signals to digital signals. The receiver 14 also comprises a processor 34 connected to the analog/digital converter 32₁-32₄ configured to process the digital signals. As can be seen in FIG. 1, the output signal from the receiver 14 is issued by the processor 34.

The portable unit 10 may comprise e.g. a mobile telephone, a mobile communication, a personal digital assistant, a handheld computer, a navigation equipment or a portable computer.

In one embodiment, the receiver comprises a GPS receiver 14 or an Assisted GPS receiver 14. In another embodiment, the receiver comprises a Galileo receiver 14, or an Assisted Galileo receiver 14. According to a further embodiment, the receiver comprises a combination of a Galileo receiver and a GPS receiver 14.

With the receiver 14, each satellite signal is received using the antenna sector that has the highest gain in the direction which the satellite is currently facing. The current orientation of the receiver 14 can be determined by means of the aid of the orientation device 20. With the help of GPS data, which tells the location of every satellite, the receiver 14 determines what antenna sector to use for a particular satellite.

Each RF digitizer channel 26₁-26₄ can be used to receive signals from one or several satellites as long as they are received through the same antenna sector. As the satellites associated with the signals are always above the horizon, the number of RF digitizer channels 26₁-26₄ can be lower than the number of antenna sectors.

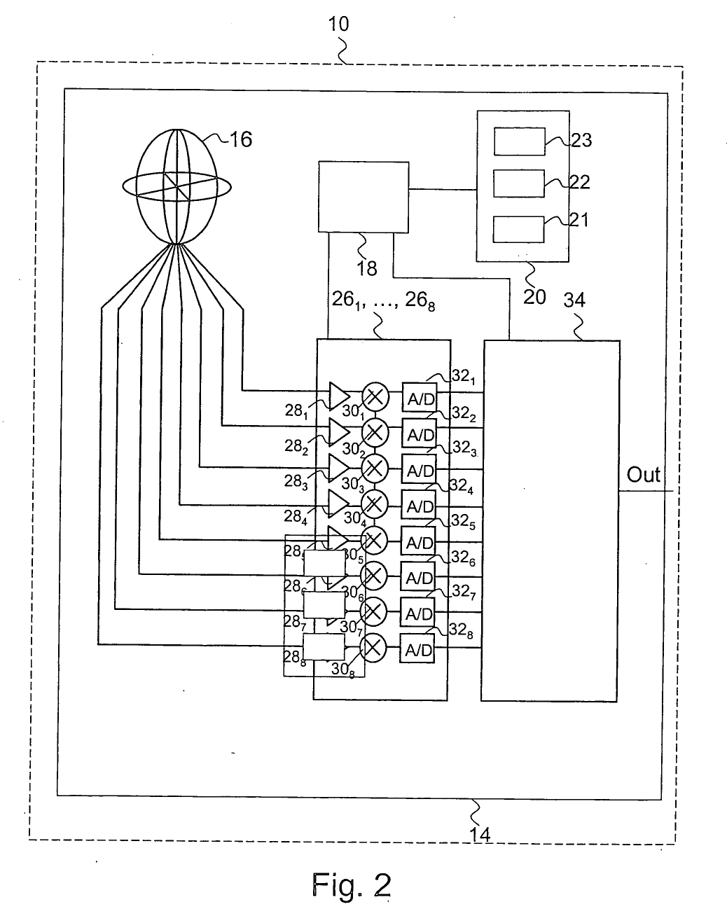

FIG. 2 shows a block diagram of a second embodiment of a receiver 14 according to the invention. One advantage of the invention is the increase in the sensitivity of a receiver 14 for a satellite based navigation system, wherein the receiver 14 is intended for use in a portable unit 10. Similar components in FIGS. 1 and 2 are referred to with similar reference signs. In the second embodiment in FIG. 2, there is one RF digitizer channel 26₁-26ₙ for each antenna sector. The general case will consequently comprise a number n of antenna sectors and a number n of RF digitizer channels 26₁-26ₙ, wherein n is an integer, and n≧2. As can be seen in FIG. 2, no switch matrix is needed. The embodiment works in the same way as the embodiment disclosed in FIG. 1, and will not be described in more detail herein.

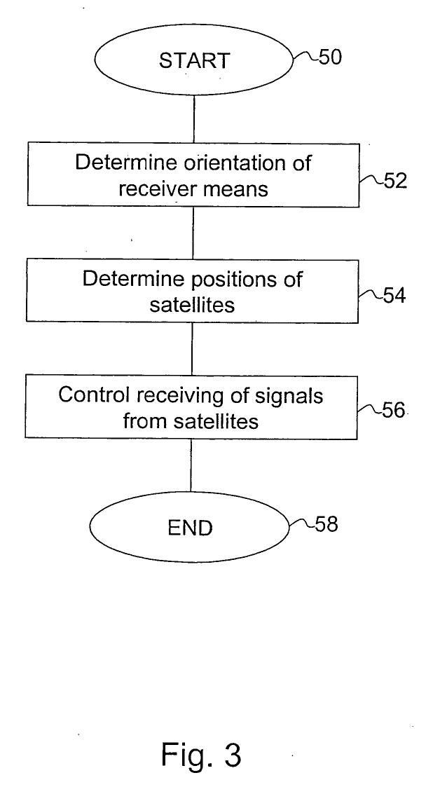

FIG. 3 shows a flow chart of a method for increasing the sensitivity of a receiver for a satellite based navigation system according to one embodiment of the invention. The receiver 14 is, in one example, intended for use in a portable unit 10 (see FIGS. 1 and 2). The method begins at 50, and continues at 52 with determining a current orientation of the receiver 14. Thereafter, at 54, the method continues with determining a current position of each satellite. The method continues at 56, wherein with the aid of a controller 18 (see, e.g., FIGS. 1 and 2) a dynamic control of the receipt of signals from each satellite is performed by using a sector of a number n of sectors of an antenna 16 comprised in the receiver 14, with the highest gain in a current direction of the satellite, wherein n is an integer, and n≧2. The method is completed at 58.

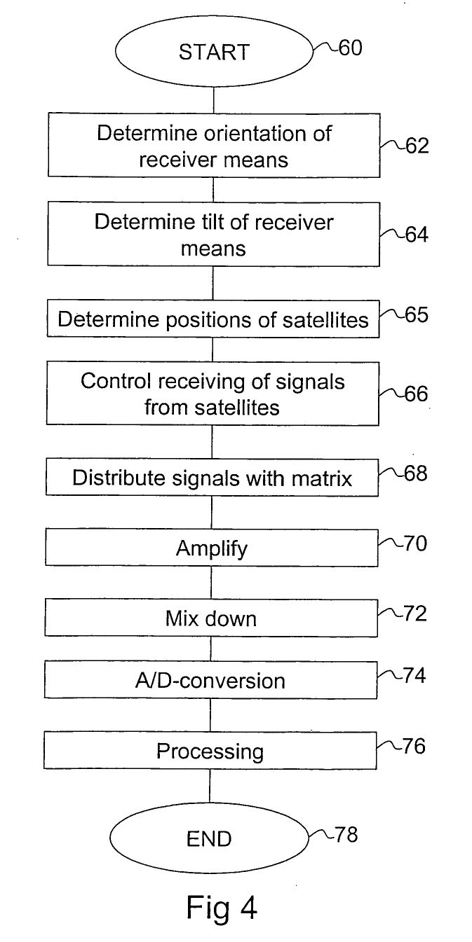

FIG. 4 represents a more detailed flow chart of an embodiment of the method in FIG. 3. The method is intended for increasing the sensitivity of a receiver 14 for a satellite based navigation system according to the invention. The receiver 14 is, in one example, intended for use in a portable unit 10 (see FIG. 1). The method begins at 60 and continues at 62 with determining a current orientation of the receiver 14. Thereafter, at 64, the method continues with sensing and determining a current tilt of the receiver 14 with the aid of a tilt sensor 22 in the receiver 14. Thereafter, at 65, the method continues with determining a current position of each satellite. The method continues at 66, with, via the aid of a controller 18 comprised in the receiver 14, a dynamic control of the receipt of signals from each satellite by using a sector, of n number of sectors of an antenna 16 comprised in the receiver 14, with the highest gain in a current direction of the satellite, wherein n is an integer, and n≧2. Thereafter, at 68, the method continues with distributing signals from the n antenna sectors to a number m of RF digitizer channels 26₁-26ₘ (see, e.g., FIG. 1) comprised in the receiver 14 with the aid of control signals from the controller 18. The method continues at 70 with amplifying the m signals from the antenna sectors. Thereafter, at 72, the method continues with mixing down the amplified signals to a lower frequency band. The method continues at 74 with performing an analog/digital conversion on each signal. Thereafter, at 76, the method continues with processing the digital signals after the conversion, and the method is completed at 78.

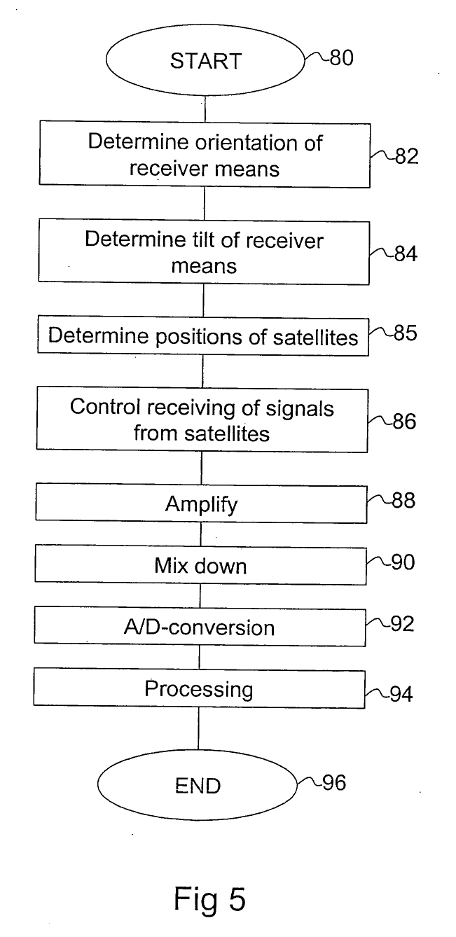

FIG. 5 represents a more detailed flow chart of another embodiment of the method disclosed in FIG. 3. The method is intended for increasing the sensitivity of a receiver 14 for a satellite based navigation system according to the invention. The receiver 14 is, in one example, intended for use in a portable unit 10 (see, e.g., FIG. 2). The method begins at 80, and continues at 82 with determining a current orientation of the receiver 14. Thereafter, at 84, the method continues with sensing and determining a current tilt of the receiver 14 with the aid of a tilt sensor 22 comprised in the receiver 14. The method continues at 85 with determining a current position of each satellite with the aid of satellite navigation data. Thereafter, at 86, with the aid of a controller 18 comprised in the receiver 14, a dynamic control of received signals from each satellite is performed by using a particular sector of an antenna 16 comprised in the receiver 14 with the highest gain in a current direction of the satellite. The method continues at 88 with amplifying the signals from the antenna sectors. Thereafter, at 90, the method continues with mixing down the amplified signals to a lower frequency band. The method continues, at 92, with performing an analog/digital conversion on each signal. Thereafter, at 94, the method continues with processing the digital signals after the conversion, and the method is completed at 96.

In one embodiment of the method according to the invention, the portable unit 10 comprises a mobile telephone, a mobile communication, a personal digital assistant, a handheld computer, a navigation equipment, or a portable computer.

In one embodiment of the method according to the invention, the receiver comprises a GPS receiver 14 or an Assisted GPS receiver. In another embodiment of the method the receiver comprises a Galileo receiver 14, or an Assisted Galileo receiver 14. According to a further embodiment of the method the receiver comprises a combination of a Galileo receiver and a GPS receiver 14.

In another embodiment of the method according to the invention, determining a current location of the portable unit 10 is performed with a compass 20 comprised in the portable unit 10.

In still another embodiment of the method according to the invention, the tilt sensor 22 comprises a gyro 23.

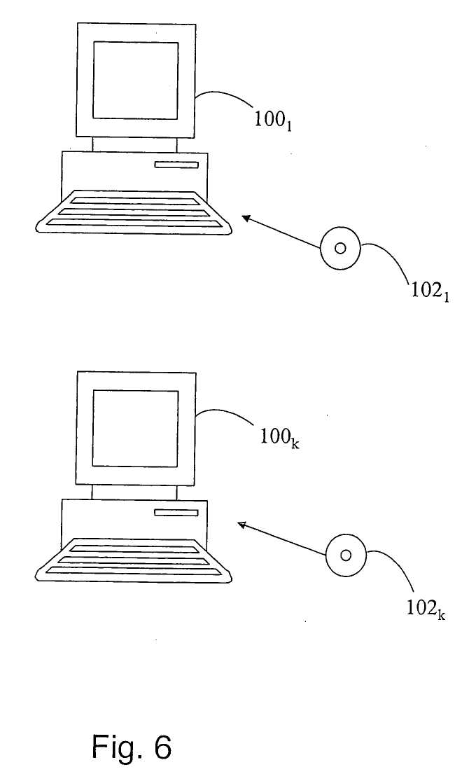

FIG. 6 shows a schematic diagram of some computer program products according to another embodiment of the invention for increasing the sensitivity of a receiver 14 for a satellite based navigation system, wherein the receiver 14 is intended for use in a portable unit 10. The figure discloses k different digital computers 100₁, . . . , 100ₖ, wherein k is an integer. The figure also discloses k different computer program products 102₁, . . . , 102ₖ, here shown in the form of compact discs. The different computer program products 102₁, . . . , 102ₖ are, in one example, directly loadable into the internal memory of the k different digital computers 100₁, . . . , 100ₖ. Each computer program product 102₁, . . . , 102ₖ comprises software code portions for performing some or all of the actions of the method of FIG. 3 when the product(s) 102₁, . . . , 102ₖ is/are run on said computer(s) 100₁ . . . , 100ₖ. Said computer program products 102₁, . . . , 102ₖ may be stored on floppy disks, RAM disks, magnetic tapes, opto magnetical disks or any other suitable products.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A receiver for a satellite based navigation system, comprising:
an antenna comprising n sectors, wherein n is an integer, and n≧2;
a controller operably associated with the means;
an orientation device connected to the controller and configured to determine a current orientation of the receiver,
wherein the controller is configured to dynamically control the receiver so that signals from a satellite are received by using a particular sector of the antenna with the highest gain in a current direction of the satellite, in order to increase the sensitivity of the receiver, and
wherein the particular sector of the antenna is used based on the location of a satellite providing the signal and based on the current orientation of the receiver.

2. The receiver of claim 1, wherein the orientation device comprises a compass and a tilt sensor configured to sense and determine a current tilt of the receiver.

3. The receiver of claim 1, wherein the orientation device comprises a compass and a gyro.

4. The receiver of claim 1, wherein the orientation device comprises a three axis compass.

5. The receiver of claim 1, wherein the receiver further comprises:
a switch matrix operably coupled to the antenna with n inputs and m outputs, wherein m is an integer, and m<n; and
m RF digitizer channel operably coupled to the switch matrix, wherein the switch matrix is configured to distribute signals from the antenna sectors to the RF digitizer channels with the aid of control signals from the controller.

6. The receiver of claim 5, wherein each RF digitizer channel comprises:
an amplifier configured to amplify the signals from the respective antenna sector;
a mixer operably connected to the amplifier and configured to mix down the amplified signals to a lower frequency band; and
an analog/digital converter operably connected to the mixer and configured to convert the mixed, amplified signals to a digital signal.

7. The receiver of claim 6, wherein the receiver further comprises a processor operably connected to each analog/digital converter, and configured to process the digital signals from the analog/digital converters.

8. The receiver of claim 7, wherein the controller is connected to the RF digitizer channels and to the processor.

9. The receiver of claim 1, wherein the receiver further comprises n RF digitizer channels, wherein each channel is connected to a respective sector of the antenna.

10. The receiver of claim 1, wherein the receiver resides in a portable unit that comprises a mobile telephone, a mobile communicator, a personal digital assistant, a handheld computer, a navigation equipment, or a portable computer.

11. The receiver of claim 1, wherein the receiver comprises a GPS receiver, an Assisted GPS receiver, a Galileo receiver, an Assisted Galileo receiver, or a combination of a Galileo receiver and a GPS receiver.

12. A method for increasing a sensitivity of a receiver for a satellite based navigation system, the method comprising:
determining a current orientation of the receiver;
determining a current position of a plurality of satellites providing satellite signals to the receiver; and
dynamically controlling the received satellite signals by using a particular sector of a multi-sector antenna in the receiver with a highest gain in a current direction of the respective satellite, wherein the particular sector of the antenna is based on the position of the satellite providing the satellite signal and on the current orientation of the receiver.

13. The method of claim 12, wherein determining the current orientation of the receiver comprises:
determining a direction of the receiver in relation to the magnetic north with a compass comprised in the receiver; and
sensing and determining a current tilt of the receiver with a tilt sensor comprised in the receiver.

14. The method of claim 12, wherein determining the current orientation of the receiver comprises:
determining the direction of the receiver in relation to the magnetic north with a compass comprised in the receiver; and
sensing and determining a current tilt of the receiver with a gyro comprised in the receiver.

15. The method of claim 12, wherein determining the current orientation of the receiver is performed with a three axis compass comprised in the receiver.

16. The method of claim 12, wherein the dynamic control comprises distributing signals from the antenna sectors to a plurality of RF digitizer channels in the receiver based on control signals, wherein the control signals control a switch matrix with n inputs, and m outputs, wherein n and m are integers, and m<n.

17. The method of claim 16, wherein in the RF digitizer channels, the method further comprises:
amplifying the signals from the antenna sectors;
mixing down the amplified signals to a lower frequency band; and
performing an analog/digital conversion of each signal.

18. The method of claim 17, further comprising processing the digital signal after the conversion.

19. The method of claim 12, wherein the dynamic control comprises forwarding satellite signals from the n antenna sectors to n RF digitizer channels comprised in the receiver.

20. The method of claim 12, wherein the receiver resides in a portable unit that comprises a mobile telephone, a mobile communicator, a personal digital assistant, a handheld computer, a navigation equipment, or a portable computer.

21. The method of claim 12, wherein the receiver comprises a GPS receiver, an Assisted GPS receiver, a Galileo receiver, an Assisted Galileo receiver, or a combination of a Galileo receiver and a GPS receiver.
